(19) United States
(12) Patent Application Publication
(10) Pub. No.: US 2011/0066554 A1
(43) Pub. Date: Mar. 17, 2011

(54) METHODS OF MEDIA ASSET DISTRIBUTION BY EMPLOYING ELECTRONIC APPARATUS

(76) Inventor: Yang Pan, (US)

(21) Appl. No.: 12/951,033

(22) Filed: Nov. 20, 2010

Related U.S. Application Data
(62) Division of application No. 12/496,486, filed on Jul. 1, 2009.

(51) Int. Cl. G06F 21/00; G06Q 30/00

(52) U.S. Cl. 705/51; 705/26.1

(57) ABSTRACT

A method is disclosed for distributing media assets by employing a new electronic apparatus. Selected media assets are pre-loaded to the apparatus based upon a targeted user's personal profile. The operation of “pre-loading” may be conducted at a manufacturing site or at a point of sales. The selected assets are encoded. The user may purchase a pre-loaded asset through a pre-paid credit system or through an on-line payment facility. The purchased asset may be decoded based upon a public/private key method. The invention is characterized by that the storage system of the electronic apparatus is managed by a software module. Each pre-loaded media asset is assigned to a priority in a sequential manner. The lower priority assets are deleted, in a manner un-notified to the user, when the storage capacity is required as a result of the user's operation of the apparatus.

### CROSS-REFERENCE TO RELATED APPLICATIONS

This application is a division of the U.S. patent application Ser. No. 12/496,486.

### BACKGROUND

1. Field of Invention

This invention relates generally to media asset distribution. More specifically, the invention describes methods for distributing media assets by the use of an electronic apparatus.

2. Description of Prior Art

There have been different approaches for delivering media assets to a consumer. Various electronic apparatus have been utilized. For example, a song stored in a compact disk can be delivered to a user using a high-fidelity home audio system. It has recently become popular to deliver media assets to a user by employing portable media players. The assets can be transferred from a server in the Internet to a portable media player connecting to a personal computer. A portable media player stores media assets, which can be played on the device. Examples of portable media players are the iPod from Apple Inc. of Cupertino, Calif., the Zen from Creative Technology Ltd, Singapore and the Zune from Microsoft Inc of Redmond, Wash. The portable media players have gained popularity because of its capability to store large number of media assets. The device can be put into a user's pocket when one travels. The portable media players have also been integrated with other portable devices such as mobile communication devices. An example of the successful implementation is the iPhone from Apple.

A media player acquires its media assets from a computer with media management applications, such as the iTunes software, which is a product from Apple. The selection and purchasing of media assets from an on-line merchandiser is performed with the use of the computer. The merchandisers have developed methods, based upon for example the iTunes from Apple, to display on a computer display screen recommended media assets to a user while the user is managing the media database. The recommended media assets are related closely to one or a group of assets in the database being processed.

For a multimedia experience, a typical consumer spends more time with an electronic apparatus such as a home audio system or a portable media player than with a personal computer. It should also be noted that a number of users or potential users of electronic apparatus may not be skillful enough to operate a personal computer. Therefore, it is desirable that the recommended media assets are stored directly in an electronic apparatus and the user can purchase the asset directly without employing a computer. On the other hand, however, some users may object that the merchandiser uses part of the storage capacity paid by a consumer in an electronic apparatus to assist to sell a media asset.

Accordingly, it is an object of the present invention to provide a method for distributing media assets to a user by employing an electronic apparatus. Recommended media assets are encoded and are pre-loaded to the apparatus before it is shipped to the user. The user may purchase a media asset directly by the use of the apparatus only.

It is another object of the present invention to provide a method to manage the storage capacity of the electronic apparatus. A portion of the storage capacity is used to store all recommended media assets from a merchandiser. The lowest priority asset is deleted automatically in a repeating manner till the capacity requirement is met if the storage capacity is required when the user is operating the apparatus. In such an approach, only “idling” storage capacity is used for storing the recommended media assets. The user has all the storage capacity available for his or her usage.

### SUMMARY OF THE INVENTION

The invention described herein pertains to a method that recommended media assets are pre-loaded to an electronic apparatus before it is shipped to the user. The media assets are encoded and stored in a predefined storage zone of the storage unit. The capacity of the zone is managed by a software module in a manner that the user is accessible to all the storage capacity as the capacity is required by the user. A portable media player (music player) is used as an exemplary illustration of the present invention.

In one aspect of the present invention, each media asset is associated with a metadata. The metadata is descriptive for the asset which is a data file and includes a format with multiple fields for holding data indicating the name of the album the track is from, the name of the asset, the genre of the asset. There are two added fields in the present invention in comparison to conventional ones. One of them indicates the type of asset that can be taken as “visible” or “hidden” file. Another indicates the priority of the asset with regard to the use of the storage capacity.

For data files and media assets other than pre-loaded ones, they have a field indicator as “visible”. Such data files or assets may be presented to a user in a conventional way as implemented in the iPod in an exemplary case. For pre-loaded media assets, they are stored in a predefined zone of the storage unit. All pre-loaded assets have a field indicator as “hidden” and are organized similarly as those assets owned by the user. Play-lists of the hidden assets are invisible to a user with a conventional operation of the media player. The pre-loaded media assets may become visible to the user after a specific user interaction with the media player through the user interface.

To effectively utilize the storage capacity of a portable media player, the storage unit can be divided into three zones. Zone-user is used to store media assets own by the user. Zone-user may also be used to store other data files. Zone-buffer is a buffered storage capacity. Zone-hidden is used to store the pre-loaded media assets. Zone-user has the higher priority than Zone-hidden whenever there is a competing requirement on the storage capacity. A portion of the storage capacity for the media player is assigned to the Zone-hidden for storing pre-loaded media assets. The storage capacity of Zone-hidden may be reduced when the user's operation of the apparatus requires more storage capacity beyond existing capacity in the Zone-user.

All media assets have a field indicator indicating their priorities. When it is necessary that the Zone-hidden capacity is reduced to give a room to the Zone-user, the pre-loaded media assets are removed sequentially according to their priorities. The lowest priority asset is removed first and the process is repeated until there is a sufficient storage capacity for the Zone-user or all the storage capacity of the apparatus is used up. The processor in the media player is with a software module to manage the storage capacities for different zones of the storage unit. The Zone-hidden may be invisible to the user providing the storage capacity in the player is always available to the user whenever it is required.

According to one aspect of the present invention, selected media assets are pre-loaded to the Zone-hidden at a manufacturing site or at a point of sales. The media assets may be selected based upon the user's personal profile. The personal profile is a user specific file indicating the user's interests in specific groups of media assets. In one implementation of the present invention, when a user orders a media player from a merchandiser, the user's personal profile may be transferred from the user to the merchandiser. The merchandiser can then determine the media assets to be loaded up to the media player according to the user's profile before the device is shipped to the user.

The encoded media assets must be decoded before they are used for playback. The media assets may be encrypted using the public and private key methodology as well known in the art. A private key is issued to the user to decode the selected asset only after the user purchases the asset.

According to one implementation, the user pays for a credit for the future purchasing of at least portion of recommended media assets when he or she purchases the media player. The credit is stored in the device before it is shipped to the user. Part of the credit is deducted after the user selects a media asset. The user may top up the credit through an on-line facility or at the point of sales when the credit is used up.

According to another implementation, the user pays through an on-line facility when he or she selects a media asset. For such an implementation, the media player requires a communication unit to connect to a server in a communication network such as the Internet.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of functional blocks of a portable media player as an exemplary case of an electronic apparatus,

FIG. 2 is a schematic diagram of a file format for storing filed data and file attributes with added fields for the “visibility” and the “priority” for a media asset,

FIG. 3 is a schematic diagram of a storage space for a media player divided into three zones: Zone-user, Zone-buffer and Zone-hidden,

FIG. 4 is a flow diagram of depicting steps for distributing media assets by the use of a portable media player. The media assets are selected and are pre-loaded up to the media player before it is shipped to the user,

FIG. 5 is a flow diagram of depicting steps for selecting media assets based upon the user's personal profile,

FIG. 6 is a flow diagram of depicting steps for managing the storage unit capacity by a software module,

FIG. 7 is a flow diagram of depicting steps for adjusting priorities for pre-loaded media assets based upon the history of the user's selection of the media assets,

FIG. 8 is a flow diagram of depicting steps according to one implementation for the user to pay for a selected media asset by deducting from a stored credit in the media player,

FIG. 9 is a flow diagram of depicting steps according to another implementation for the user to pay for a selected media asset by deducting from a stored credit in the media player. The stored credit may be toped up through an on-line facility,

FIG. 10 is a flow diagram of depicting steps according to yet another implementation for the user to pay for a selected media asset through an on-line facility.

### DETAILED DESCRIPTION

References will now be made in details to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

The term “electronic apparatus” used in this disclosure generally refers to computing devices that are used at least to processing media assets such as audio, video, text or multi-media assets. The electronic apparatus may also be used for other functions such as, for example, connecting to a communication network such as the Internet. Examples of electronic apparatus include high-fidelity home audio systems, car audio systems, electronic books, portable music players and mobile phone integrated with media players.

The term “media player” used in this disclosure generally refers to computing devices that are dedicated to processing media assets such as audio and video assets. In one implementation, the media player is a portable computing device. Examples of media players include music players, game players, video players, electronic books, video recorders, cameras, and the like. These media players are generally portable so as to allow a user to listen to music, play games or video, read text, record video or take pictures wherever the user travels. The media player is a portable device that is sized for placement into a pocket of the user. By being pocket sized, the user does not have to directly carry the device and therefore the device can be taken almost anywhere the user travels.

The “media player” is a sub-group of the “electronic apparatus” in the present disclosure and the media player is used as an exemplary case of the electronic apparatus in the description.

The media player typically has connection capabilities that allow a user to upload and download data to and from a host device such as a general purpose computer. With regard to music player, songs and playlists stored on the general purpose computer may be downloaded into the music player. In our description of the invention, a music player is taken as an exemplary case for the purpose of the illustration but not limit the scope of the invention.

The basic operation of a media player (music player) is described as follows. A portable media player comprises a processor and a file storage system that is typically a flash memory or a plurality of flash memories. It further comprises user interface unit such as a Liquid Crystal Display (LCD) screen and a user input device such as a rotational user input device used in some iPod's from Apple. The file system stores media assets. A user selects a media asset from the user interface. The processor receives the selection and controls the operation of sending the selected media asset to coder/decoder (CODEC) for the signal processing to generate analog signal for further delivering to speakers for an audio experience in case of a music player. The media player has a data link for connecting to a computer. A battery, more particularly, a rechargeable battery is used to provide power for the player.

The media player includes a user input device that allows a user to interact with the device. For example, the user input device can take a variety of forms, such as a button, keypad, dial, etc. A rotational user interface as implemented by Apple in some iPod's has gained significant popularity. Since the display screen associated with a handheld media player is typically small, an efficient user interface is required to allow a user intuitively navigate among, and select, songs to be played. The operation typically includes an overlapping hierarchy of categories. Categories include items that can also be included in other categories so that the categories overlap with each other. Thus, a song title can be accessed in multiple different ways by starting with different categories. For example, the top-level categories “Album”, “Artists”, “Genres” and “Playlists” are presented to a user first. Within the Albums category are names of different albums of songs stored in the device. Within each album are album tracks, or songs, associated with that album. Similarly, the Artists category includes names of artists which are, in turn, associated with their albums and songs. The Genre category includes types of categories of music such as “Rock”, “Classical”, “Pop”, etc. Within these sub-categories are found associated songs. Finally, the “Playlists” category includes collections of albums and/or songs which are typically defined by the user.

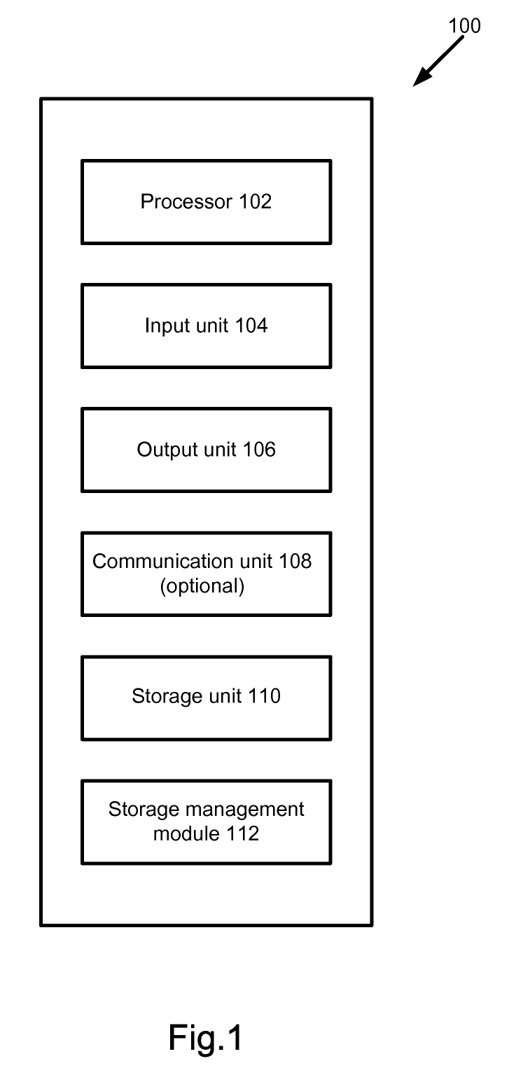

FIG. 1 is a schematic diagram of the functional blocks of a media player 100. The media player 100 may comprise a processor 102 to control operations of the device, an input unit 104 and an output unit 106. The input unit 104 may comprise a rotational user input device, keys and touch pads. The output unit 106 may comprise a Liquid Crystal Display (LCD) screen. The exemplary media player 100 may further comprise a communication device 108 as an optional functional block. The communication device 108 may be a wireless transceiver conforming to various IEEE standards and their amendments such as IEEE 802.11 (WLAN), IEEE 802.15.1 (Bluetooth) and IEEE 802.15.4 (ZigBee). The media player 100 may also include a file storage unit 110. The file storage unit 110 is typically a semiconductor flash memory device or a plurality of flash memory devices or a magnetic storage device such as a hard disk driver. The file storage unit 110 may also include a cache to improve the data access time. The file storage system 110 is managed by a software module 112 through the processor 102. The media player 100 is powered by a battery or more specifically a re-chargeable battery (not shown in the figure).

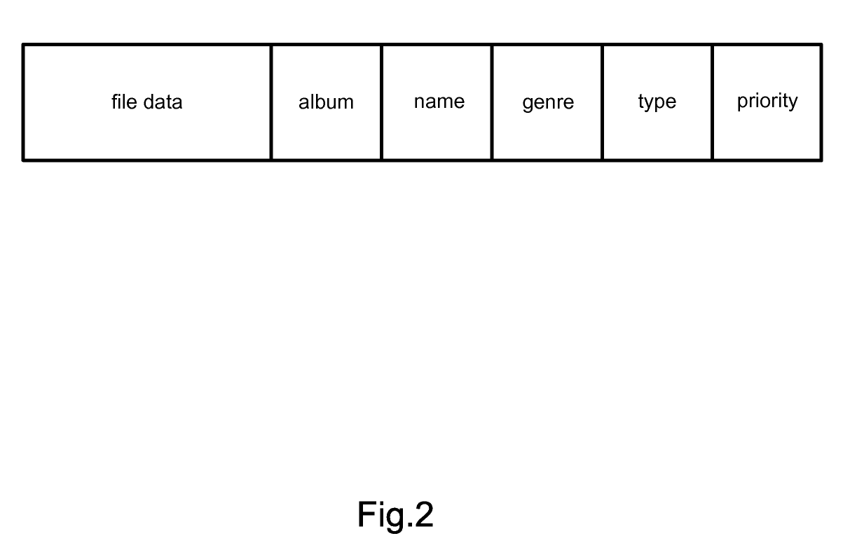

FIG. 2 is a schematic diagram of the media file format including file data in the form of MP3 track as an example for an audio asset (a song). The metadata fields for holding data indicate the name of the album the track is from, the name of the song, the genre of the song and the type of the track. The data format further includes two additional fields. One is used to indicate a file status of ‘visible’ or ‘hidden’. The media assets owned by the user have a status indicator of ‘visible’ that is visible to the user operating the media player in the sense of the conventional user interface. A pre-loaded media asset owned by a merchandiser has a status indicator “hidden”, which is invisible to the user. The “hidden” assets may be organized into a separate play-list, which requires additional user interaction with the user interface to make the assets visible. Another added field is to indicate the priority of the stored media files. For media assets owned by the user, they have a default priority “1” without difference. All other data files stored in the player also have a default priority “1”. The files with the priority “1” are typical with a visibility indicator as “visible”. For hidden media assets, they are assigned a priority starting from “2” to whatever number it takes to rank all hidden media assets sequentially.

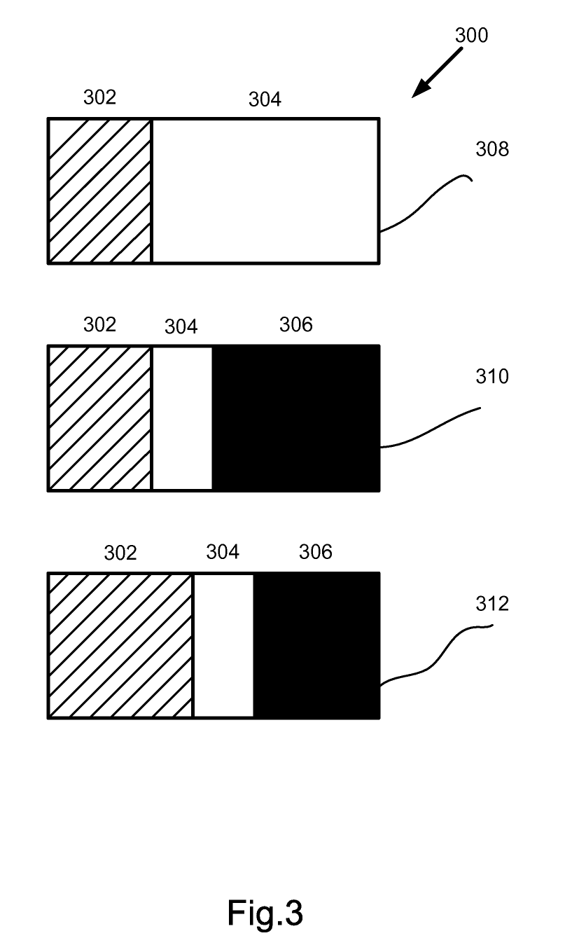

FIG. 3 is a diagram of a storage space for a media player divided into three zones for different applications. A storage system 300 includes a required storage space 302 and an unused storage space 304 as shown in 308. The required space 302 is used to store all media assets owned by the user and all other conventional data files. The fact that a storage capacity is typically not fully utilized is known for most media players in the market. With increasing in flash memory density and reduction in price, more and more memory “bits” are to be placed into a media player. It is common that significant portion of storage capacity associated with a media player is unused. The present invention is intended to use these unused storage capacity more effectively. A portion of unused storage capacity 304 may be utilized to store the pre-loaded media assets indicated as the Zone-hidden 306 in 310. The storage unit 110 of the media player 100 thus can be divided into three zones: 302, 304 and 306. The Zone-user 302 is used to store all media assets owned by the user and all other conventional data files. The Zone-buffer 304 is an unused buffer space between the Zone-user 302 the Zone-hidden 306. 306 is used to store all pre-loaded media assets. Because it takes sometime for a typical apparatus to clear a occupied storage capacity, the Zone-buffer 304 is used to smooth the operation, which makes the operation un-notified by the user.

The media assets stored in Zone-user 302 have higher priority than the assets stored in Zone-hidden 306. If more storage capacity is required as a result of the user's operation of the apparatus, the capacity of the Zone-user 302 is expanded automatically while the capacity of Zone-hidden 306 is reduced accordingly as shown in 312. The lowest priority asset is removed in a repeating manner to allow the expansion of Zone-user 302. The Zone-user 302 is expanded continuously until the Zone-user 302 acquires sufficient capacity or all the pre-loaded media assets are removed. The operation is controlled by the processor 102 of the media player 100 in the background and may be un-notified by the user.

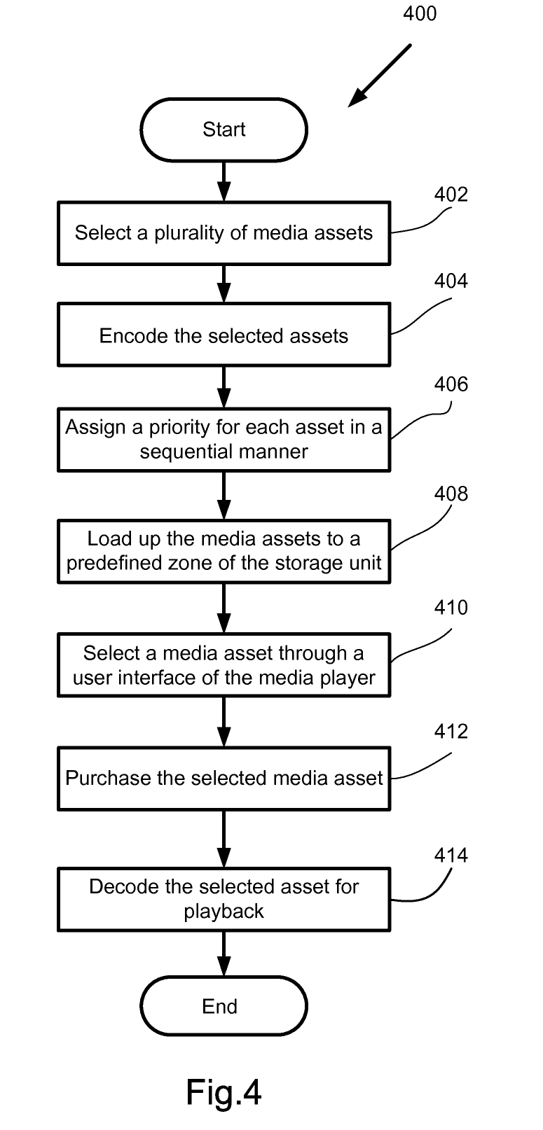

FIG. 4 is a flow diagram of depicting steps for distributing media assets by employing a portable media player 100. The media assets are selected and are loaded up to the media player before it is shipped to the user. Process 400 starts with step 402 that a plurality of media assets is selected. The step 402 may be conducted at a manufacturing site or at a point of sales. The selection of the assets may be based upon a targeted user's personal profile, which is a file indicating the user's interest in specific media assets. The personal profile may be delivered from the user to the merchandiser through an on-line facility or through the user's input operation with a server at the point of the sales. The method of selecting media assets based upon the user's personal profile is well established in the art. In the exemplary illustration, all selected media assets are encoded in step 404 although in some other implementations portion of assets may be encoded. Each asset is assigned a priority in step 406. The priority for the selected assets may start from “2” and may continue to whatever number it takes to rank all the selected assets. The priority “1” is reserved for the media assets owned by the user and for all other conventional data files. In step 408, all selected media assets are loaded up to the Zone-hidden 306 of the storage unit 110. The storage capacity of Zone-hidden 306 is predefined.

After a new media player 100 is received by the user, a pre-loaded media asset may be selected through a user interface in step 410 by a specific interaction between the user and the media player 100. The user purchases the asset in step 412. After the payment, the asset is decoded in step 414 for playback. The priority for paid asset is changed to “1” and the visibility is changed to “visible”.

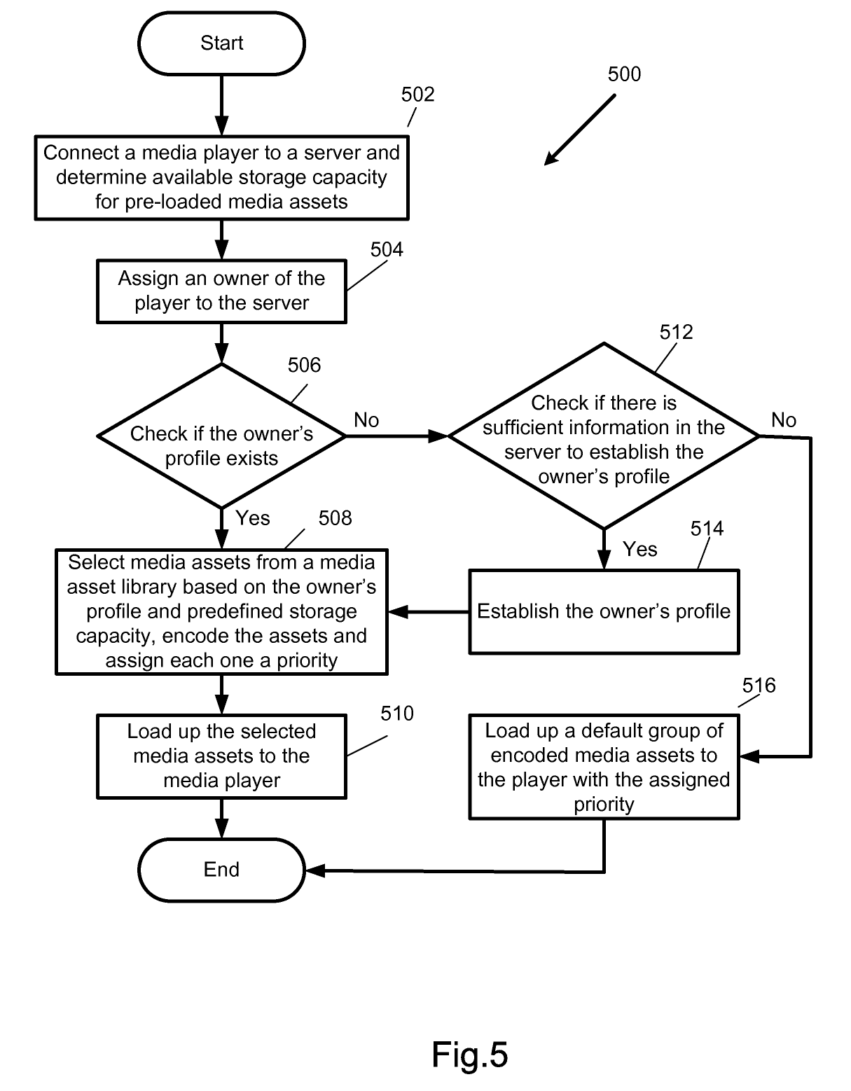

FIG. 5 is a flow diagram of depicting steps for selecting media assets based upon the user's personal profile. The process 500 starts with step 502 connecting a media player 100 to a server. The storage capacity for storing selected media assets is predefined. In step 504, an owner is assigned to the media player 100. The owner is typically the user who purchased the device. In step 506, it is checked if the owner's personal profile has already been established. If the result is positive, media assets are selected in step 508 from a media asset library based upon the owner's personal profile. In step 510, the selected media assets are loaded up to the Zone-hidden 306 of the storage unit 110. If the result is negative as a result of the step 506, it is checked in step 512 if there is sufficient information in the server to establish the owner's personal profile. If the result is positive for the step 512, the personal profile is established in step 514 and media assets are then selected and loaded up in the steps 508-510. If the owner's personal profile could not be established in the step 512, a default group of media assets are loaded up to the media player 100 in step 516.

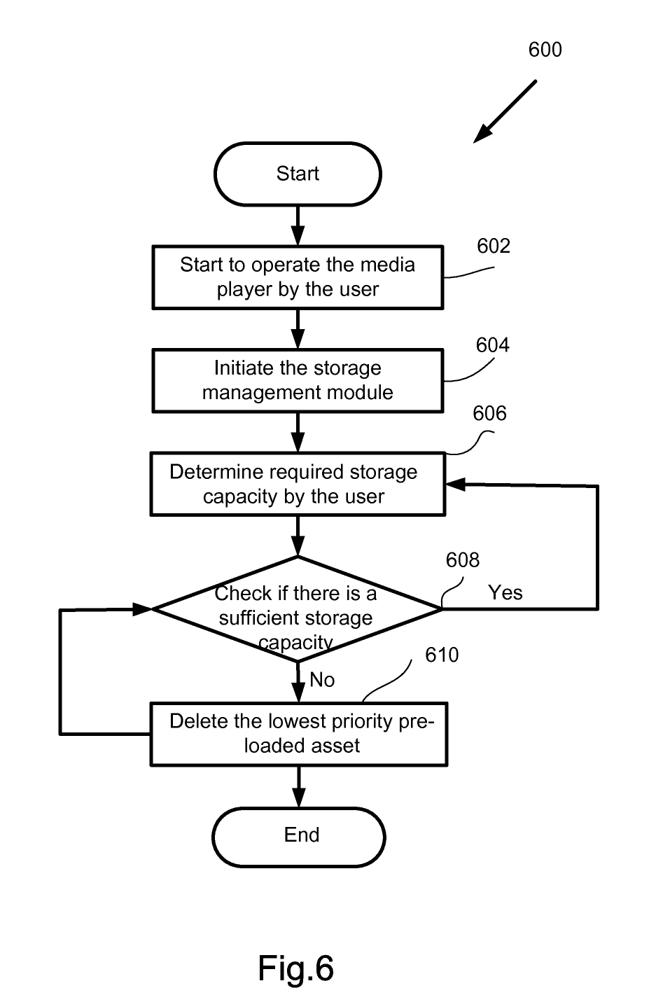

FIG. 6 is a flow diagram of depicting steps for managing the capacity of the storage unit 110 by the software module 112. Process 600 starts with step 602 that the user starts to operate the media player 100. The software module 112 is initiated immediately to manage the storage capacity in step 604. The required storage capacity for the user is determined on a real time base in step 606. In step 608, it is checked if the Zone-user 302 has the sufficient reserved capacity. If the result is negative, the lowest priority asset in Zone-hidden 306 is deleted in a repeating manner until a sufficient capacity is opened up for the Zone-user 302 or all pre-loaded assets are deleted.

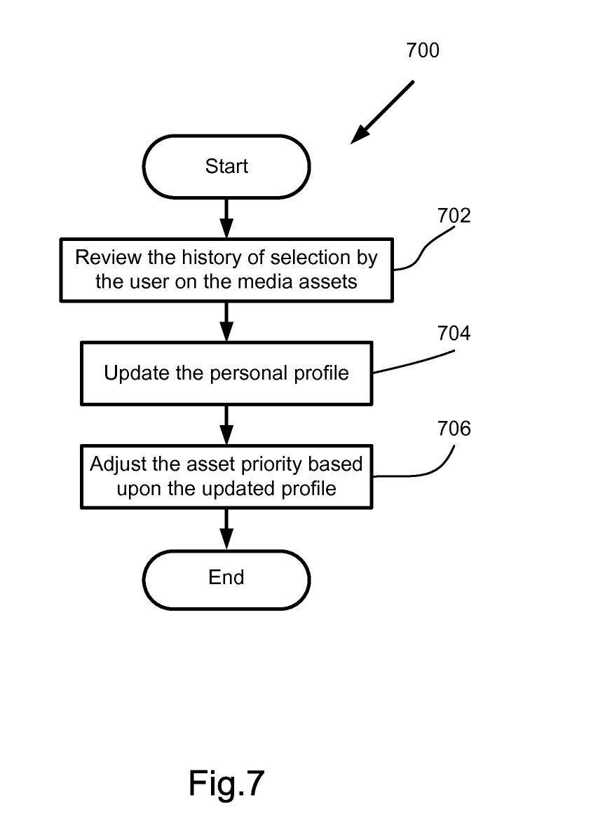

FIG. 7 is a flow diagram of depicting steps for adjusting priorities for pre-loaded assets based upon the history of the user's selection of the media assets. The process 700 starts with step 702 that the user's history of the selection of the recommended assets is reviewed. The user's personal profile is then updated in step 704. The priority for each pre-loaded asset is then adjusted in step 706 based upon the updated personal profile.

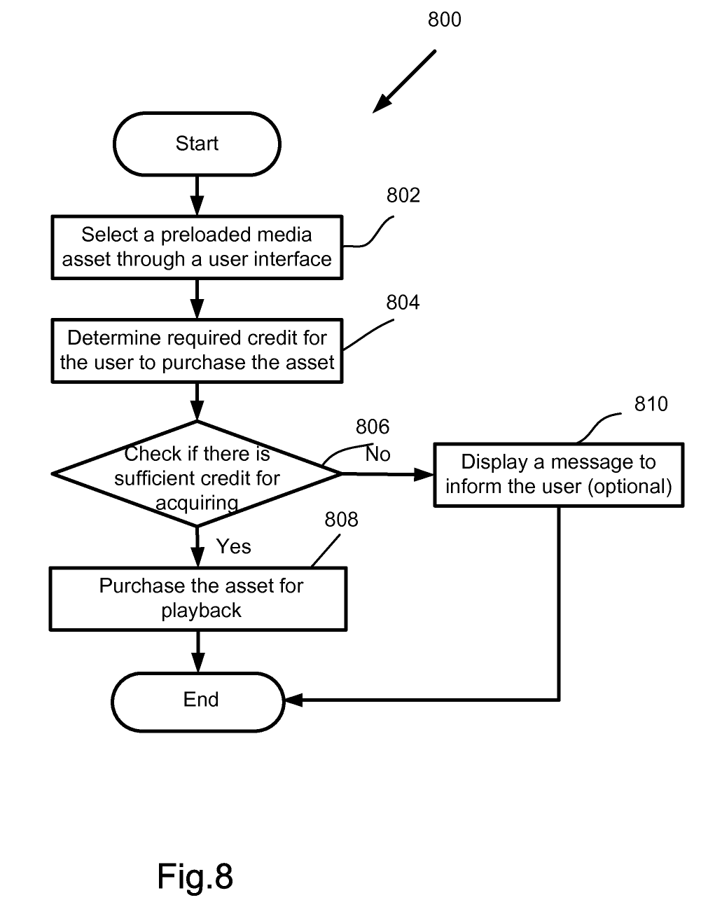

FIG. 8 is a flow diagram of depicting steps according to one implementation for the user to pay for a selected media asset by deducting from a stored credit in the media player 100. The user may have already paid for the credit after purchasing of the device. The paid credit has already been stored in the media player 100 at the time that the device is delivered to the user. Process 800 starts with step 802 that a pre-loaded media asset is selected by the user through a user input unit 104 through a specific interaction. A required credit for the asset is then determined in step 804. In step 806, it is checked if the remaining credit is sufficient for the asset. If the result is positive, the asset is purchased in step 808. Otherwise a message is displayed in step 810 on the output unit 106 that the credit is insufficient for purchasing the selected asset.

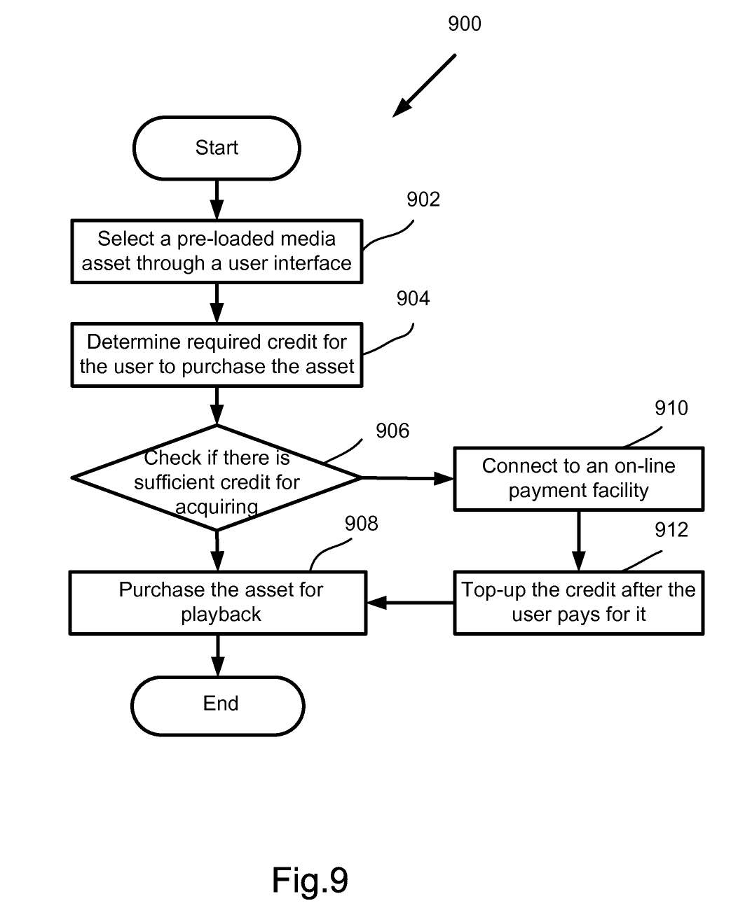

FIG. 9 is a flow diagram of depicting steps according to another implementation for the user to pay for a selected media asset by deducting from a stored credit in the media player 100. The stored credit may be toped up through an on-line facility. Process 900 starts with step 902 that a pre-loaded media asset is selected by the user through the user input unit 104. A required credit for the asset is then determined in step 904. In step 906, it is checked if the remaining credit is sufficient for the asset. If the result is positive, the asset is acquired in step 908. If the result is negative, the media player 100 is connected to an on-line facility in step 910 and the user pays for the top up of the credit in step 912. After acquiring more credit, the selected asset is purchased.

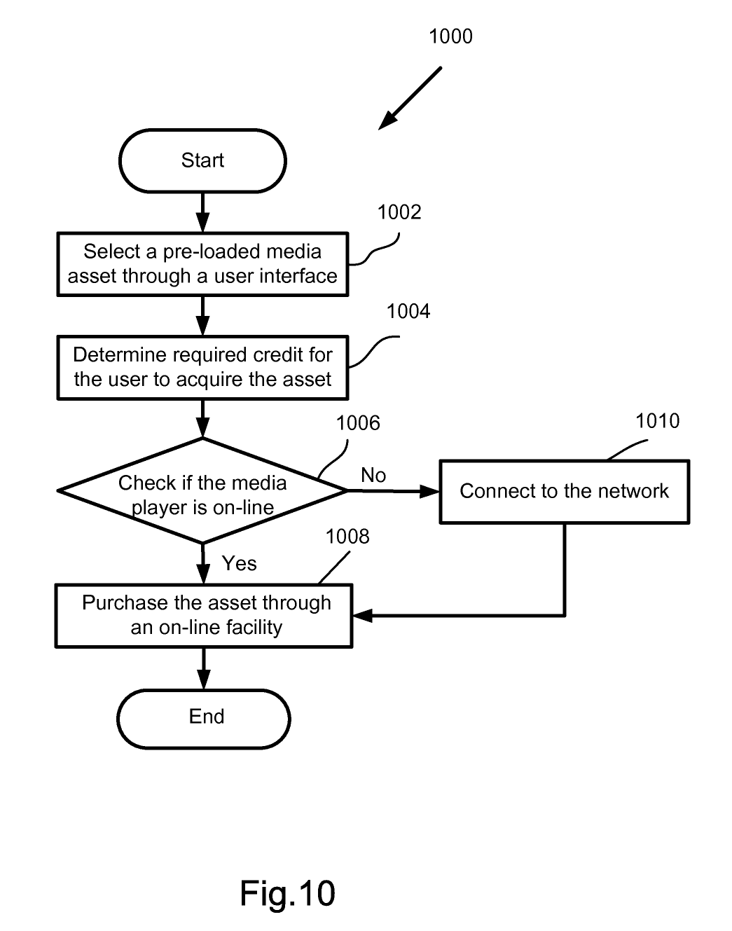

FIG. 10 is a flow diagram of depicting steps according to yet another implementation for the user to pay for a selected media asset through an on-line facility. Process 1000 starts with step 1002, that a pre-loaded media asset is selected through a specific user interaction with the media player 100. The required credit for purchasing of the asset is determined in step 1004. In step 1006, it is checked if the media player 100 is connected to a communication network. If the result is positive, the selected asset is acquired in step 1008 through an on-line payment facility. Otherwise, the media player 100 is connected to the network in step 1010 to enable the completion of the purchasing process.

While the invention has been disclosed with respect to a limited number of embodiments, numerous modifications and variations will be appreciated by those skilled in the art. A handheld media player is used as an exemplary case to illustrate the invention. The inventive concept, however, can be extended to other electronic apparatus such as home high-fidelity audio/video systems, vehicle audio/video systems, personal computing devices, electronic books and handheld mobile computing and communication devices. The media assets may include audio files, video files, text, games, advertisement messages and multimedia files. It is intended that all such variations and modifications fall with in the scope of the following claims:

1. A method of delivering media assets to a user by a merchandiser using an electronic apparatus comprising a processor, an input unit, an output unit and a storage unit with a storage capacity for storing data files, the method comprising the following steps:
a. selecting a plurality of media assets by the merchandiser;
b. assigning a priority for each asset in a sequential manner;
c. loading up the selected media assets to the storage unit of the electronic apparatus;
d. selecting one media asset from the loaded media assets by the user; and
e. purchasing the selected media asset,
wherein the method is characterized by that the storage capacity of the storage unit is managed by a software module through the use of the processor and the lower priority media assets are deleted automatically in an unnoticeable to the user if at least a portion of the storage capacity used by the pre-loaded media assets is required as a result of the user's operation of the apparatus.

2. The method as recited in claim 1, wherein at least one selected media asset is encoded and the encoded asset is decoded after the user purchases the asset.

3. The method as recited in claim 1, wherein said step a) to c) may be performed in a server at a manufacturing site or at a point of sales before the apparatus is delivered to said user.

4. The method as recited in claim 1, wherein said operation of “selecting” in the step a) may be performed based upon the user's personal profile comprising information of the user's personal interests in specific media asset group.

5. The method as recited in claim 4, wherein the user's personal profile may be sent to the server through a communication network or be established by the user at the point of sales.

6. The method as recited in claim 1, wherein said electronic apparatus may be selected from the following group:
a. a portable media player;
b. a home high fidelity audio/video system;
c. a vehicle audio/video system
d. a personal computing device;
e. an electronic book; and
f. a handheld mobile computing and communication device.

7. The method as recited in claim 1, wherein said operation of “purchasing” at the step e) further comprising a step as:
deducting at least a portion of a credit associated with the apparatus if at least one media asset is purchased by the user, wherein said credit is assigned to the apparatus at the manufacturing site or at the point of sales.

8. The method as recited in claim 7, wherein said operation of “assigning” a credit is performed through purchasing a credit by employing an on-line facility during the user's operation of the apparatus.

9. The method as recited in claim 1, wherein said operation of “purchasing” at the step e) further comprising steps as:
a. connecting the electronic apparatus to a communication network; and
b. purchasing a credit through an on-line facility.

10. The method as recited in claim 1, wherein said operation of “purchasing” at the step e) is performed through an on-line facility.
